(19) United States
(12) Patent Application Publication
(10) Pub. No.: US 2011/0014255 A1
(43) Pub. Date: Jan. 20, 2011

(54) PHYTOSANITARY FORMULATION GENERATING NANOPARTICLES, METHOD FOR PREPARING NANOPARTICLES AND USE THEREOF

(76) Inventor: Marc Balastre, Paris (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/520,479

(22) PCT Filed: Dec. 21, 2007
(86) PCT No.: PCT/FR2007/064420

§ 371 Date: Oct. 1, 2010

(30) Foreign Application Priority Data
Dec. 22, 2006 (FR) 06/11359

(51) Int. Cl. A01N 25/00; A01N 43/653

(52) U.S. Cl. 424/405; 514/383; 977/773; 977/902

(57) ABSTRACT

The present invention relates to a phytosanitary formulation capable of generating nanoparticles. The formulation includes a solvent having a low water miscibility, an active ingredient and at least one amphiphilic compound. The formulation is concentrated and is intended to be diluted in water by a farmer. The present invention also relates to a method for preparing nanoparticles of a phytosanitary active ingredient using the formulation of the invention.

The present invention relates to a crop protection formulation which is capable of generating nanoparticles. The formulation comprises a solvent of low miscibility in water, an active ingredient, and at least one amphiphilic compound. It is a concentrated formulation intended for dilution in water by the farmer. The present invention also relates to a process for preparing nanoparticles of an active crop protection ingredient, using the formulation of the invention.

Numerous active compounds are used in agriculture, such as fertilizers or pesticides, examples being insecticides, herbicides or fungicides. They are referred to as crop protection products. These active compounds or crop protection products are generally produced in a pure or highly concentrated form. On farms they must be used at low concentrations. For this purpose, the active compounds are generally formulated with other ingredients in order to allow easy weight dilution by the farmer. These formulations are referred to as crop protection formulations. The dilution carried out by the farmer is generally accomplished by mixing the crop protection formulation with water.

Hence crop protection formulations must allow easy weight dilution by the farmer, so as to produce a product in which the crop protection product is properly dispersed, in the form, for example, of a solution, emulsion, suspension or suspoemulsion. Crop-protection formulations thus permit the transport of a crop protection product in a relatively concentrated form, and permit easy packaging and/or easy handling for the end user. Various types of crop protection formulations may be used, according to the different crop protection products. Examples include emulsifiable concentrates (EC), dispersible concentrates (DC), suspension concentrations (SC), wettable powders (WP), and water-dispersible granules (WDG). The formulations it is possible to use depend on the physical form of the crop protection product (for example, solid or liquid), and on its physicochemical properties in the presence of other compounds such as water or the solvents.

Following weight or volume dilution by the farmer, by mixing with water, for example, the crop protection product may be in a variety of physical forms: solution, dispersion of solid particles, dispersion of droplets of the product, droplets of solvent in which the product is dissolved, etc. The crop protection formulations generally comprise compounds which allow these physical forms to be obtained. These compounds may be, for example, surfactants, solvents, mineral supports, or dispersants. Very often these compounds do not have an active character but instead have an intermediary character for aiding formulation. It is thus quite often desired to limit the amount of these compounds in order to limit the costs and/or any environmental unfriendliness. The crop protection formulations may especially be in a liquid form, or in a solid form, in the form, for example, of powder or granules.

For practical reasons, preference may be given to using crop protection formulations in liquid form. Formulations of this kind have the advantage, especially, of not generating dust and therefore of not raising questions of the effect on health when there are particles present in the air that is breathed.

Document EP 1023832 describes a process for preparing suspension concentrates (SC) in water of solid particles of an active crop protection ingredient. The suspensions comprise water, the active ingredient, an adjuvent able to reduce the surface tension on spraying, which does not promote growth of the particles, and at least one nonionic or anionic surfactant. The suspensions are prepared by grinding processes, and the particles are micron-sized.

Document EP 1087658 describes processes for preparing microdispersions of solid particles of a solid active crop protection ingredient. In one process the active ingredient is melted, an emulsion is made of the active ingredient in melted form, and then this emulsion is cooled, to give solid particles dispersed in water. In another process, the active ingredient is dissolved in a water-immiscible solvent, the solution is emulsified in water, and then the solvent is removed, to give particles of the active ingredient dispersed in water. In one process the active ingredient is melted in the presence of a surfactant and optionally in the presence of a cosurfactant, an emulsion is made of the active ingredient in melted form, and then this emulsion is cooled, to give solid particles dispersed in water. The cosurfactants which may be employed are heptyl acetate (water-immiscible), NMP (total miscibility in water), butyrolactone (total miscibility in water), or octyl pyrrolidone (miscibility in water of not more than 0.1%). The preparation process described comprises numerous steps and is not practical to implement. Moreover, the compositions obtained have a relatively high water content (of the order of 50% by weight), which is undesirable for reasons of transport cost. A need exhibits for simpler processes, and for simpler compositions.

Nanoparticles of active crop protection ingredients have also been described. Document WO 02/082900 indicates that the nanoparticles may have increased biological activity in comparison with emulsified droplets, or with micron-sized particles.

Document WO 02/082900 describes more specifically a process of forming nanoparticles of active crop protection ingredients by mixing water and a composition comprising the water-insoluble active crop protection ingredient, a water-miscible solvent such as methanol (totally miscible with water), and an amphiphilic compound, for example, a block copolymer deriving from unsaturated monomers.

Document WO 03/039249 describes solid formulations of primarily amorphous nanoparticles of active crop protection ingredients, and their dispersions in water. The formulations comprise a particular random free-radical copolymer. In one process (“precipitation route”) the particles may be obtained by very vigorous mixing of an aqueous solution of the copolymer with a solution of the active ingredient in a water-miscible solvent, followed by solidification by removal of the water and the solvents, by means, for example, of spray drying, freeze drying or drying in a fluidized bed. The solvents have a miscibility of at least 10%. The examples employ completely water-miscible solvents. The particles following the dispersion in water have a hydrodynamic diameter of 10 to 500 nm.

Document WO 2005/087002 describes a process for preparing a dispersion of crop protection particles which are said to be nanometric, by mixing with water a solution of the active ingredient in a water-miscible solvent, in the presence, where appropriate, of a surfactant. Numerous solvents are cited: NMP (complete water miscibility), DMSO (complete water miscibility), sulfolane (complete water miscibility), acetone (complete water solubility), ethanol (complete water miscibility), DMF (complete water miscibility), acetophenone (0.55% miscibility in water), methanol, (complete miscibility in water), butyrolactone (complete miscibility in water), cyclohexanone (2.4% miscibility in water), dimethylacetamide (complete miscibility in water), and C₁-C₄ alkyl esters of lactates (miscibility in water ranging from 4.5% to 100% depending on the length of the alkyl chain). The examples employ solvents of complete miscibility in water: novaluron in solution in DMSO (completely water miscible), or tebuconazole in solution in ethyl lactate (completely water miscible). The particle size is not given in the examples.

Document WO 2006/002984 describes concentrated formulations of pesticides that comprise a pesticide, at least one amphiphilic compound (poly(ethylene oxide)-poly(propylene or other oxide) block copolymer), and a solvent with a miscibility in water of greater than 1%, preferably at least 5%, in particular at least 10%. The formulations are said to form particles, by mixing with water, with a size of less than 500 nm. In the examples, solvents of high miscibility are used. The document, especially a study of example 10 and comparative example A (pages 42 and 43), shows that, for the solvents of complete miscibility that are used, the use of the block copolymers makes it possible, after dilution, to stabilize the change in particle size over time; the initial formation of the particles on dilution, probably switching in water of the miscible solvent, remains obtained irrespective of the amphiphilic system (block copolymer or amphiphilic compound). There is a need for other solutions for forming nanoparticles, allowing the active ingredients employed and the solvents employed to be varied.

There exists, furthermore, a continual need for different formulation systems that allow variation in the active crop protection ingredients, the forms in which they are used (especially liquid forms), their efficacy (especially an absence of crystallization or a low level of crystallization, since crystallization may be detrimental to the biological efficacy), while managing constraints of practical use (good stability, good sprayability, absence of crystallization or low level of crystallization, absence of nozzle clogging, etc.).

The invention responds to the needs and/or to the limits expressed above, by providing a liquid crop protection formulation capable of forming, by mixing with water, solid or liquid nanoparticles of a water-insoluble active crop protection ingredient, and comprising:
a) a water-insoluble organic active crop protection ingredient,
b) a partially water-miscible solvent system whose miscibility in water is between 0.001% and 10%, preferably between 0.001% and 1%, and
c) an amphiphilic system, preferably a system comprising a surfactant,

with the proviso that, if the amphiphilic system is composed only of a block copolymer of ethylene oxide and C₃-C₁ alkylene oxide, then the solvent system has a miscibility in water of less than 1%.

The formulation of the invention may be dubbed a “nano dispersible concentrate” (NDC).

It has been found, surprisingly, that it is possible to form nanoparticles of active crop protection ingredients using solvents that are partially water-miscible that have a very low miscibility in water.

The invention may especially allow formulations and nanoparticles to be produced of a large variety of active ingredients (especially by virtue of the use of solvents having a high solvency). The invention may especially make it possible to maximize the active ingredient contents in the formulations (especially by virtue of the use of solvents having a higher solvency). This has an advantage in terms of cost of transport, of storage and/or of handling.

The formulations and the nanoparticles generated from them may especially have a high efficacy. The high efficacy makes it possible for greater effects to be obtained and/or for equal effects to be obtained using less active compounds, which is beneficial, and/or is at least perceived as being beneficial, for the environment, and which is advantageous in terms of cost.

The invention also relates to a process for preparing the formulation. The invention also relates to a process for preparing a dispersion of nanoparticles of the organic active crop protection ingredient by mixing the formulation with water. The invention also relates to the use of the formulation to prepare nanoparticles of an organic active crop protection ingredient. The operation of mixing with water is advantageously carried out by the farmer. Consequently the formulation may be referred to as a tank-mix formulation. The invention also relates to the use of the formulation and/or of the dispersion for treatment of plants.

The operation of mixing with water and of forming nanoparticles can be particularly simple, and may not necessitate substantial stirring. Stirring may even be superfluous. This simplicity has advantages in terms of handling time and/or reproducibility for the farming user.

Lastly, the formulation and/or the dispersion of nanoparticles have original optical properties which are appreciated by the user and may enable him or her to distinguish the liquids with ease. The formulation is generally single-phase, homogeneous, and often clear, while the nanoparticle dispersion is generally clear with a slight color, and iridescent color, for example, which may be pinkish or bluish.

Definitions

In the present application a “water-insoluble active ingredient” is a compound whose solubility in water is less than or equal to 0.5 g/l, preferably to 0.2 g/l, but which may be soluble in the solvent system. Without constituting a preference, it is mentioned that there is no intention to exclude the possibility of the active ingredient being dissolved in water at levels less than or equal to 0.01 g/l.

In the present application, the miscibility of a solvent in water is expressed in % (by weight).

In the present application, nanoparticles are particles with a size of less than 1000 nm. With regard to the size, it is the hydrodynamic radius of the particles, obtained by light scattering measurement, carried out, for example, on a Malvern ALV CGS-3. The diameters may be measured, for example, at 90° (D₉₀) and 135° (D₁₃₅) angle. The autocorrelation function allows two values to be obtained: the average hydrodynamic diameter weighted by the scattered intensity, and a polydispersity index (dimensionless, labeled Iₚ), which is close to zero for a monodisperse sample. The particle size is the hydrodynamic diameter. It may be considered as being the smallest of the two values indicated for 90° and for 135°.

Formulation and Process for Preparing the Formulation

The formulation of the invention is liquid. The liquid character may be evaluated at the temperature of use, for example, at 20° C. The formulation may be prepared by simple, more or less vigorous, mixing of its constituent ingredients. The ingredients may be introduced for mixing separately, or in the form of premixes of some of them. It is mentioned that, since the formulation is liquid, the process of preparing this liquid formulation, which can be used directly, will typically not include a step of drying, evaporation, concentration, extrusion and/or granulation. The implementation of a drying operation or partial evaporation is not, however excluded, for the purpose, for example, of adjusting the concentration of active ingredient. In that case, preference would be given to not removing more than 50%, preferably not more than 25%, by weight of liquids. Preferably, not more than 50%, preferably not more than 25%, by weight of the solvent is removed. It is stated that the formulation may sometimes be converted in the course of a subsequent step into a solid formulation, for example, by extrusion, granulation, atomization or impregnation of a powder, granules or an extrudate.

The formulation of the invention typically comprises little water or comprises no water. If the formulation comprises water, the amount of water relative to the amount of solvent system is typically such that the water/solvent system mixture is miscible. In other words, the amount of water is less than the maximum of water that can be introduced into the solvent system without phase separation. In other words, the amount of water is less than the miscibility limit of water in the solvent system.

The formulation may, for example, contain less than 23% by weight of water, preferably less than 20%, preferably less than 15%, preferably less than 10% by weight, preferably less than 1% by weight. In one advantageous embodiment, if the formulation comprises water, it comprises only the water that may be present in the ingredients: advantageously, there will be no additional introduction of water.

The formulation is capable of forming nanoparticles by mixing with water. Typically, the formulation of the invention will be able to be such that:
it is single-phase, and
it forms an oil-in-water emulsion, by mixing with water, having at least a proportion of water relative to the solvent of D_{Emuls}, D_{Emuls} being preferably between 5/95 and 95/5, preferably between 50/50 and 95/5,
it forms a nanoparticle dispersion, by mixing with water, having at least a proportion of water relative to the solvent, D_{Nano}, of greater than D_{Emuls}, D_{Nano} being preferably between 5/95 and 99.999/0.001, preferably between 95/5 and 99.999/0.001, preferably between 99/1 and 99.995/0.005, and preferably between 99.5/0.5 and 99.95/0.05.

The formulation as it is is therefore typically single-phase, which means that it presents no phase separation visible to the eye. It may be clear, especially if it comprises little water or contains no water at all. By clear is meant that characters with a height of 2 mm can be read through a thickness of 2 cm of the formulation. It is mentioned that the formulation may alternatively be single-phase and opaque. By opaque is meant that characters with a height of 2 mm cannot be read through a thickness of 2 cm of formulation.

Following mixing with water, the formulation may form an oil-in-water emulsion, at least at a proportion of water relative to the solvent of D_{Emuls}. The emulsion may for example be characterized by a turbid, nonclear character (characters 2 mm in height cannot be read through a thickness of 2 cm of formulation). The emulsion phase may especially exist over a range of proportions, for example, over a range of proportions of at least 25% of the ranges mentioned earlier on above. The emulsion may especially be off-white. The diameter of the droplets of the emulsion, dispersed in water, may especially be greater than 1 μm, or even 2 μm.

Beyond the proportion D_{Emuls}, the formulation may form a dispersion of nanoparticles, with a proportion of water relative to the solvent of D_{Nano} which is greater than D_{Emuls}. At this proportion, the dilute formulation may especially become clear again, with a color, where appropriate, which has a pinkish or bluish iridescence. The nanoparticles may be present over wide ranges of proportions in water, for example, over at least 25%, preferably at least 50%, and even 100% of the ranges mentioned earlier on above.

Without wishing to be tied to any one theory, it is thought that the existence of an intermediate state in emulsion form at modest dilutions may contribute to the formation of nanoparticles at greater dilutions. It is thought that the emulsion becomes emptied in the course of the subsequent dilution, before then, finally, forming nanoparticles. Phenomena of this kind cannot be observed with highly water-miscible solvents, for which the mechanisms of formation are likely very different. It is thought that the formation of nanoparticles is due to physicochemical phenomena which are quite different from encapsulation techniques. The formulation is preferably free from beads or capsules of polymers or from inorganic capsules. During the preparation of the formulation of the invention, it is preferred not to use beads of polymers or of polymer crosslinking systems to form bead or capsule walls.

The nanoparticles may be solid or liquid nanoparticles whose average diameter is measured by light scattering is between 10 and 1000 nm, preferably between 20 and 500 nm, preferably between 50 and 400 nm, for example, between 100 and 300 nm. The nanoparticles advantageously have an amorphous character. A morphology of this kind may be beneficial to the efficacy. The morphology may be evaluated by optical microscopy under crossed polarizers: an absence of birefringence indicates an amorphous character.

The formulation may especially comprise:
from 1% to 89.9% by weight of the organic active crop protection ingredient,
from 10% to 80% by weight of the partially water-miscible solvent system, and
from 0.1% to 35% by weight, preferably from 1% to 30%, of the amphiphilic system.

In one particular embodiment the formulation contains from 7% to 30% by weight of the amphiphilic system, preferably from 10% to 25% by weight.

In one particular embodiment the weight ratio between the organic active crop protection ingredient and the amphiphilic system is between 0.5 and 5, preferably between 1 and 3.

In one particular embodiment the weight ratio between the organic active crop protection ingredient and the solvent system is between 0.05 and 5, preferably between 0.2 and 2.

Active Ingredient

Nonlimiting examples of active ingredients that may form part of the formulation include, among others, ametryne, diuron, linuron, novaluron, chlortoluron, isoproturon, nicosulfuron, metamitron, diazinon, aclonifen, atrazine, chlorothalonil, bromoxynil, bromoxynil heptanoate, bromoxynil octanoate, mancozeb, maneb, zineb, phenmedipham, propanyl, the phenoxy-phenoxy series, the heteroaryloxyphenoxy series, CMPP, MCPA, 2,4-D, simazine, the active products of the imidazolinone series, the class of the organo-phosphorous compounds, including especially azinphos-ethyl, azinphos-methyl, alachlor, chlorpyriphos, diclofop-methyl, fenoxaprop-p-ethyl, methoxychlor, cypermethrin, alpha-cypermethrin, phenmedipham, propanil, oxyfluorfen, dimethoate, imidacloprid, propoxur, benomyl, deltametrin, fenvalerate, abamectin, amicarbazone, bifenthrin, carbosulfan, cyfluthrin, difenconazole, ethofenprox, fenoxaprop-ethyl, flu-azifop-p-butyl, flufenoxuron, hexazinone, lambda-cyhalothrin, permethrin, prochloraz, methomyl, fenoxy-carb, cymoxanil, chlorothalonyl, the neonicotinoid insecticides, the class of triazole fungicides such as azaconazole, bromuconazole, cyproconazole, difeno-conazole, diniconazole, epoxiconazole, fenbuconazole, flusilazole, myclobutanil, tebuconazole, triadimefon, triadimenol, strobilurins such as pyraclostrobin, picoxystrobin, azoxystrobin, famoxadone, kresoxim-methyl and trifloxystrobin, sulfonylureas, such as bensulfuron-methyl, chlorimuron-ethyl, chlorsulfuron, metsulfuron-methyl, nicosulfuron, sulfomethuron-methyl, triasulfuron, and tribenuron-methyl.

A mixture of active ingredients may be contemplated in the formulation.

The water-insoluble organic active ingredients that are of particular interest are especially tebuconazole, cyproconazole, propiconazile, chlorothalonil, fipronil, cypermethrin, cymoxanil, nicosulfuron, isoproturon, linuron, oxasulfuron, bensulfuron-methyl, thidiazuron, sulfosulfuron, triasulfuron, chlorbromuron, chloro-methiuron, triadimefon, beta-cypermethrin, carbendazim, haloxyfop, profenofos, prometryn, thiobencarb, and chlorfenprop.

It is possible especially to employ an azole, preferably tebuconazole. It is possible especially to employ dinitroanilines, such as pendimethalin or trifuralin.

Solvent System

The solvent system may comprise a single solvent, or a combination or mixture of two or more solvents. Where a combination of two or more solvents is involved, the miscibility of the solvent system is included in the miscibility of the mixture of solvents of the solvent system. Often the miscibility of a mixture is close to the average of the miscibilities, weighted by the relative weight proportions of each solvent. Still in this case, it is mentioned that the various solvents may be introduced into the formulation separately, or in the form of a mixture prepared beforehand (in which case reference may be made to a solvent composition). It is noted that the solvent system may comprise solvents of complete miscibility in water or relatively high miscibility in water (greater than 10%), and/or water-immiscible solvents, which in that case are in combination or in a mixture with solvents of partial miscibility (less than or equal to 10%, preferably to 1%). The solvent system may thus comprise, for example, at least 33% by weight, preferably at least 50%, preferably at least 90%, or even 100% of solvents said to have partial miscibility.

The solvent system especially may comprise at least 33% by weight, preferably at least 50%, preferably at least 90%, of a solvent selected from the following solvents:
N,N-dialkyl amides of a carboxylic acid, preferably an N,N-dimethyl amide of a C₆-C₁₈ carboxylic acid
ketones
alkylpyrrolidones in which the alkyl group is C₃-C₁₈, preferably C₆-C₁₂
aldehydes
monoesters, diesters or oxalates
ethers
halogenated solvents
alcohols
phosphate, phosphonate, phosphinate, phosphine, or phosphine oxide solvents
nitriles
amines, preferably alkylamines, dialkylamines, trialkylamines, or heterocyclic amines, in which the alkyl groups are C₁-C₁₈
lactones
carbonates
mixtures or combinations thereof,

said solvents, mixtures or combinations having a miscibility in water of between 0.001% and 10%, preferably between 0.001% and 1%.

Solvents which can be used include especially the solvents of the following type:
The class of the amides, alkyl amides, and dialkyl amides, with especially the AlkylDiMethylAmides (ADMA) where the alkyl is, for example, C₂-C₂₀, more particularly N,N-dimethyldecanamide (miscibility 0.034%) and N,N-dimethyloctanamide (miscibility 0.43%), or mixtures with different sizes of alkyls. Mention is made especially of the compounds sold by Rhodia, Rhodiasolv® ADMA810 and Rhodiasolv® ADMA10, and of the compounds sold by Clariant under the Genegen® name.
Ketones such as cyclohexanone (miscibility 2.3%), acetophenone (miscibility 0.55%), isophorone (miscibility 1.2%), and methyl isobutyl ketone (miscibility 1.7%).
Alkyl lactams, especially alkylpyrrolidones such as N-octylpyrrolidone (miscibility 0.1%).
The class of monoesters, diesters or oxalates, for example, butyraldehyde (miscibility 7.1%), benzaldehyde (miscibility 0.3%), styrallyl acetate, benzyl acetate (miscibility 0.001%), butyl acetate (miscibility 2.9%), propyl acetate (miscibility 2.3%), ethyl acetate (miscibility 8%), N-pentyl acetate (miscibility 1%), isoamyl acetate (miscibility 2%), isobutyl acetate (miscibility 0.67), isopropyl acetate (miscibility 2.9%), isobutyl isobutyrate (miscibility 0.5%), diethyl phthalate (miscibility 0.1%), dimethyl phthalate (miscibility 1.84%), methyl salicylate (miscibility 0.074%), benzyl salicylate (miscibility 0.005%), methyl salicylate (miscibility 0.07%), ethyl salicylate, isoamyl salicylate, diethyl malonate (miscibility 3.31%), dimethyl oxalate (miscibility 5%), dimethyl adipate (miscibility 2.5%), dimethyl oxalate, and also mixtures of diesters such as the product Rhodiasolv® RPDE sold by Rhodia (miscibility 5.3%).
The class of ester alcohols or their derivatives, such as (S)-2-hydroxybutyl propionate (Purasolv® BL), (S)-n-butyl lactate (miscibility 4.5%); propanoic acid, 2-hydroxy-2-ethylhexyl ester (Purasolv® EHL), ethylhexyl S-lactate (miscibility 0.03%), and diethylene glycol n-butyl ether (miscibility 6.5%).
The class of ethers such as anisole (miscibility 1.04%), dimethoxymethane (miscibility 2.4%), epichlorohydrin (miscibility 6.58%), and diphenyl ether (miscibility 0.002%).
The class of halogenated solvents such as 1,1-dichloroethane (miscibility 5.03%) and dichloro-methane (miscibility 1.3%).
The class of alcohols such as benzyl alcohol (miscibility 0.08%), 2-ethylbutanol (miscibility 0.63%), 2-ethylhexanol (miscibility 0.07%), 2-ethyl-1,3-hexanediol (miscibility 0.6%), 2-heptanol (miscibility 0.35%), and decanol (miscibility 0.02%).
The class of aldehydes, such as benzaldehyde (miscibility 0.3%) and furfuraldehyde (miscibility 8.3%).
The class of phosphates, such as tributyl phosphate (miscibility 0.04%), tributoxyethyl phosphate (miscibility 0.11%), and tris(2-ethylhexyl)phosphate (miscibility 0.1%).
The class of phosphonates, such as dibutyl butylphosphonate.
The class of nitriles, such as acrylonitrile (miscibility 7.35%), butyronitrile (miscibility 3.3%), and benzonitrile (miscibility 0.2%).
The class of amines, alkylamines, dialkylamines, trialkylamines, and heterocyclic amines, such as, for example, quinoline (miscibility 0.61%) and dodecylamine.
The class of lactones such as hexalactone.
The class of carbonates, such as ethylene carbonate and propylene carbonate.
The mixtures and combinations of these classes and solvents.

It is possible especially to contemplate mixtures or combinations with solvents having higher miscibilities, such as DMSO, NMP, butyrolactone, acetone, and ethanol. In one particular embodiment the formulation is free of NMP.

Among the partially miscible solvents, preference may be given to those which have a relatively polar group and a comparatively hydrophobic group. Solvents of this kind may be beneficial to the mechanism of formation described above.

Amphiphilic System

The amphiphilic system may comprise a single amphiphilic compound, or a combination or a mixture of two or more amphiphilic compounds. The skilled worker knows of amphiphilic compounds, and it may especially involve surfactants or polymers, often block polymers. The amphiphilicity is often characterized by the HLB, which is a parameter known to the skilled worker. It is often tabulated. It may be evaluated in a known way.

If the system in question is a combination of two or more amphiphilic compounds, the HLB of the amphiphilic system is understood as the HLB of the mixture of compounds of the amphiphilic system. Often the HLB of a mixture is close to the average of the HLBs, weighted by the relative weight proportions of each amphiphilic compound. Still in this case, it is stated that the various amphiphilic compounds may be introduced into the formulation separately, or in the form of a mixture prepared beforehand (in which case reference may be made to an amphiphilic composition).

The amphiphilic system may comprise a surfactant. Surfactants are known compounds which have a molar mass which is generally relatively low, for example, less than 1000 g/mol. The surfactant may be an anionic surfactant in salified or acid form, a nonionic surfactant, preferably polyalkoxylated, a cationic surfactant, an amphoteric surfactant (a term which also includes zwitterionic surfactants), or a mixture of these surfactants.

It is noted that the formulation may comprise:
at least one amphiphilic compound with a molar mass of less than 1000 g/mol, which may especially be a surfactant, and
at least one amphiphilic compound with a molar mass of greater than or equal to 1000 g/mol.

An amphiphilic compound with a molar mass of greater than or equal to 1000 g/mol may especially be a polymeric compound.

By way of examples of anionic surfactants, mention may be made, without wishing to be limited thereto, of:
alkylsulfonic acids or arylsulfonic acids, optionally substituted with one or more hydrocarbon-based groups, and the acid function of which is partially or totally salified, such as C₈-C₅₀, more particularly C₈-C₃₀, preferably C₁₀-C₂₂ alkylsulfonic acids, benzenesulfonic acids or naphthalenesulfonic acids substituted with one to three C₁-C₃₀, preferably C₄-C₁₆, alkyl and/or C₂-C₃₀, preferably C₄-C₁₆, alkenyl groups;
alkylsulfosuccinic acid monoesters or diesters, the linear or branched alkyl part of which is optionally substituted with one or more hydroxylated and/or linear or branched C₂-C₄ alkoxylated (preferably ethoxylated, propoxylated or ethopropoxylated) groups;
phosphate esters selected more particularly from those comprising at least one linear or branched, saturated, unsaturated or aromatic hydrocarbon-based group containing 8 to 40 and preferably 10 to 30 carbon atoms, optionally substituted with at least one alkoxylated (ethoxylated, propoxylated or ethopropoxylated) group. In addition, they comprise at least one monoesterified or diesterified phosphate ester group such that one or two free or partially or totally salified acid groups may be present. The preferred phosphate esters are of the type such as monoesters and diesters of phosphoric acid and of alkoxylated (ethoxylated and/or propoxylated) mono-, di- or tristyrylphenol, or of alkoxylated (ethoxylated and/or propoxylated) mono-, di- or trialkylphenol, optionally substituted with one to four alkyl groups; of phosphoric acid and of an alkoxylated (ethoxylated or ethopropoxylated) C₈-C₃₀, and preferably C₁₀-C₂₂, alcohol; of phosphoric acid and of a nonalkoxylated C₈-C₂₂, and preferably C₁₀-C₂₂, alcohol;
sulfate esters obtained from saturated or aromatic alcohols, optionally substituted with one or more alkoxylated (ethoxylated, propoxylated or ethopropoxylated) groups, and for which the sulfate functions are in free or partially or totally neutralized acid form. By way of example, mention may be made of the sulfate esters obtained more particularly from saturated or unsaturated C₈-C₂₀ alcohols, which may comprise 1 to 8 alkoxylated (ethoxylated, propoxylated or ethopropoxylated) units; the sulfate esters obtained from polyalkoxylated phenol, substituted with 1 to 3 saturated or unsaturated C₂-C₃₀ hydroxycarbon-based groups, and in which the number of alkoxylated units is between 2 and 40; the sulfate esters obtained from polyalkoxylated mono-, di- or tristyrylphenol in which the number of alkoxylated units ranges from 2 to 40.

The anionic surfactants may be in acid form (they are potentially anionic) or in a partially or totally salified form, with a counterion. The counterion may be an alkali metal, such as sodium or potassium, an alkaline earth metal, such as calcium, or an ammonium ion of formula N(R)₄⁺ in which R, which may be identical or different, represent a hydrogen atom or a C₁-C₄ alkyl radical optionally substituted with an oxygen atom.

By way of examples of nonionic surfactants, mention may be made, without wishing to be limited thereto, of:
polyalkoxylated (ethoxylated, propoxylated or ethopropoxylated)phenols substituted with at least one C₄-C₂₀ and preferably C₄-C₁₂ alkyl radical, or substituted with at least one alkylaryl radical, the alkyl part of which is C₁-C₆. More particularly, the total number of alkoxylated units is between 2 and 100. By way of example, mention may be made of polyalkoxylated mono-, di- or tri(phenylethyl)phenols, or polyalkoxylated nonylphenols. Among the ethoxylated and/or propoxylated, sulfated and/or phosphated di- or tristyrylphenols, mention may be made of ethoxylated bis(1-phenylethyl)phenol, containing 10 oxyethylenated units, ethoxylated bis(1-phenylethyl)phenol, containing 7 oxyethylenated units, ethoxylated sulfated bis(1-phenylethyl)phenol, containing 7 oxyethylenated units, ethoxylated tris(1-phenylethyl)phenol, containing 8 oxyethylenated units, ethoxylated tris(1-phenylethyl)phenol, containing 16 oxyethylenated units, ethoxylated sulfated tris(1-phenylethyl)phenol, containing 16 oxyethylenated units, ethoxylated tris(1-phenylethyl)phenol, containing 20 oxyethylenated units, and ethoxylated phosphated tris(1-phenylethyl)phenol, containing 16 oxyethylenated units;
optionally polyalkoxylated (ethoxylated, propoxylated or ethopropoxylated) C₆-C₂₂ fatty alcohols or fatty acids. When they are present, the number of alkoxylated units is between 1 and 60. The term “ethoxylated fatty acid” includes both the products obtained by ethoxylation of a fatty acid with ethylene oxide and those obtained by esterification of a fatty acid with a polyethylene glycol;
polyalkoxylated (ethoxylated, propoxylated or ethopropoxylated) triglycerides of plant or animal origin. Triglycerides derived from lard, tallow, groundnut oil, butter oil, cottonseed oil, linseed oil, olive oil, palm oil, grapeseed oil, fish oil, soybean oil, castor oil, rapeseed oil, copra oil or coconut oil, and comprising a total number of alkoxylated units of between 1 and 60, are thus suitable for use. The term “ethoxylated triglyceride” is directed both to the products obtained by ethoxylation of a triglyceride with ethylene oxide and to those obtained by transesterification of a triglyceride with a polyethylene glycol;
polyalkoxylated (ethoxylated, propoxylated or ethopropoxylated) sorbitan esters, more particularly cyclized sorbitol esters of C₁₀ to C₂₀ fatty acids, for instance lauric acid, stearic acid or oleic acid, and comprising a total number of alkoxylated units of between 2 and 50.

The polyalkoxylated, preferably polyethoxylated and/or polypropoxylated, surfactants may be particularly preferred in the context of dried emulsions.

The amphiphilic system may comprise a block copolymer, comprising a hydrophilic block containing hydrophilic units deriving from hydrophilic monomers, and the hydrophobic block containing hydrophilic units deriving from hydrophobic monomers. The compound in question may be, for example, a polymeric compound selected from:
block copolymers of ethylene oxide and C₃-C₁₀ alkylene oxide,
amphiphilic block copolymers, preferably linear, comprising at least one block, preferably at least two blocks, comprising units deriving from ethylenically unsaturated monomers.

The block copolymer is for example a diblock copolymer. Preferably at least one block, preferably two or at least two, derive from mono-alpha-ethylenically unsaturated monomers. Examples of block copolymers suitable for this embodiment are described in document WO 02/082900. Some of these block copolymers deriving from mono-alpha-ethylenically unsaturated monomers may have an effect, additionally, of inhibiting crystallization.

It will often be possible for the amphiphilic system to comprise at least one of the amphiphilic compounds selected from the following compounds:
ethoxylated and/or propoxylated fatty alcohols,
ethoxylated and/or propoxylated fatty acids,
unalkoxylated fatty acids,
block copolymers of poly(ethylene oxide) and poly(propylene oxide),
ethoxylated and/or propoxylated di- and/or tri-styrylphenols, optionally phosphated or sulfated, or
alkyl sulfates or alkylsulfonates in which the alkyl is C₆-C₃₀,
mixtures or combinations thereof.

Especially forming part of the amphiphilic system, alone or in mixtures or combinations, may be the following:
Nonionic surfactants of fatty acid or ester type, such as, for example, esters, glycol esters, glycerol esters, PEG esters, sorbitol esters, ethoxylated sorbitol esters, ethoxylated or ethoxy-propoxylated acids, esters and triglycerides (class of the Alkamuls® from RHODIA, examples being ethoxylated castor oils, Alkamuls® OR 36 (HLB=13.1), Alkamuls® RC (HLB 10.5), Alkamuls® R81 (HLB=9.2), Alkamuls® 696 (HLB 8.2).
Nonionic surfactants of ethoxylated or ethoxy propoxylated alcohol type, or polyalkylene glycol type, such as (the class of the Rhodasurf® from RHODIA, examples being Rhodasurf® LA/30 (HLB=8), Rhodasurf® ID5 (HLB=10.5), Rhodasurf® 860P (HLB=12.4)).
Ethoxylated or ethoxy propoxylated aromatic nonionic surfactants, an example being the class of the Igepal® from RHODIA.
Ethoxylated or ethoxy propoxylated block copolymers, for example the class of the Antarox® from RHODIA, such as Antarox® B848 (HLB=13.1), Antarox® PLG 254 (HLB=10), Antarox® PL 122 (HLB=5).
Anionic surfactants, such as sulfonates, aliphatic sulfonates, sulfonates carrying ester or amide groups such as isethionates (sulfo esters), taurates (sulfoamides), sulfosuccinates, sulfosuccinamates, or else sulfonates containing no amide or ester groups, such as alkyldiphenyl oxide disulfonates, alkyl-naphthalenesulfonates, naphthalene/formaldehyde-sulfonates, including, for example, dodecyl-benzenesulfonates (Rhodacal® class from RHODIA, such as, for example, Rhodacal® 60 BE (HLB=8.3)).
Phosphate esters, for example, the class of the Rhodafac® from RHODIA such as Rhodafac® PA 17 (HLB=11.7), Rhodafac® MB (HLB=9.2).
Styrylphenol-based compounds such as distyrylphenols and tristyrylphenols, which may be ethoxylated or ethoxypropoxylated, phosphated and/or sulfated, for example, the class of the Soprophors® from RHODIA such as Soprophor® DSS7, Soprophor® BSU (HLB=12.6), Soprophor 3D33 (HLB=16), Soprophor 4D384 (HLB=16), Soprophor® 796P (HLB=13.7).
Surfactants derived from terpenes, for example, the class of the Rhodoclean® from RHODIA.
Ethoxylated fatty amines, for example, the class of the Rhodameen® from RHODIA.

The amphiphilic system may especially have an HLB of greater than or equal to 6, preferably to 8, preferably between 9 and 18, preferably between 9 and 15, preferably between 10 and 13. Without wishing to be tied to any one theory, it is thought that the selection of an amphiphilic system within these ranges may be beneficial to the formulation of the nanoparticles.

In one preferred embodiment the amphiphilic system comprises:
at least one amphiphilic compound with an HLB of less than 10, and
at least one amphiphilic compound with an HLB of greater than or equal to 10.

For example, the amphiphilic system may comprise:
at least one amphiphilic compound with an HLB of less than 9, preferably less than or equal to 8, and/or
at least one amphiphilic compound of an HLB of greater than or equal to 11, preferably greater than or equal to 12.

The formulation may especially comprise at least two amphiphilic compounds having a difference in HLB of greater than or equal to 2, preferably greater than or equal to 3, preferably greater than or equal to 4.

Without wishing to be tied to any one theory, it is thought that the use of at least two amphiphilic compounds with different HLBs may be beneficial to the mechanism of formation of the nanoparticles, perhaps by emulsification and exhaustion of the droplets as described above. Such a combination may thus be particularly favorable for the formation of nanoparticles from a low-miscibility formulation based on a solvent system of partial miscibility or low miscibility.

Other Ingredients

The formulation may further comprise additives such as adjuvants, humectants, wetting agents, antifoams, thickeners, anticaking agents, crystalline growth inhibitors such as, for example, polyvinylpyrrolidone, dyes, chemical stabilizers, inert fillers, preservatives, antifreeze agents, nanoparticle size stabilizers or nanoparticle growth inhibitors, penetrants, examples being the compounds sold by Rhodia under the brand name Geronol®, etc.

Humectants include, for example, agents such as the polyethylene glycols (“PEG”), for example, PEG-200, PEG-400, PEG-2000, and PEG-4000. The PEG may also act as crystallization inhibitors.

Suitable wetting agents, without limitation thereto, include N-methyl-N-oleoyl taurates; alkylarylsulfonate salts, such as alkylbenzenesulfonate salts, alkyl diphenyl ether sulfonate salts, alkylnaphthalene-sulfonate salts; mono-alkyl sulfosuccinates, di-alkyl sulfosuccinates; and ethoxylated alkylphenols. These wetting agents may be used alone or in a mixture. As wetting surfactants mention may be made, for example, of Geropon® SDS, Geropon® T/77, Supragil® NC/85, Rhodacal® DS/10, Supragil® WP, sold by Rhodia. The amount of wetting agent may be between 0.5% and 10% by weight, relative to the total weight of the solid formulation, preferably between 1% and 5% by weight, relative to the same reference.

Without wishing to be tied to any one theory, it is thought that the wetting agents may help to make the organic or inorganic substrate compatible with the water which may be employed when the solid formulation is prepared, especially in the preparation of wettable powders and water-dispersible granules. They may also aid the dispersion in water of the solid formulation.

Chemical stabilizers include, without limitation thereto, alkaline earth metal or transition metal sulfates, sodium hexametaphosphate, calcium chloride, boric anhydride, etc.

Agents for stabilizing the size of the nanoparticles or agents which inhibit nanoparticle growth include polyvinylpyrrolidone (PVP), dicarboxylic diesters, for example, diisobutyl adipate, glutarate, and succinates or mixtures thereof, an example being the product Rhodiasolv® DIB (Rhodia).

It is specified that it is possible for one ingredient to fulfill two or more functions in the solid formulation.

Process for Preparing Nanoparticles—Use of the Formulation

The formulation of the invention can be used to prepare a dispersion of solid or liquid nanoparticles by mixing with water. Everything said above in relation to the nanoparticles which can be formed from the formulation, and the dispersions, is applicable to the process for preparing the nanoparticles. It is mentioned, however, that, in practice, mixing with water can be done in a single operation, without necessarily carrying out intermediate dilution before an emulsion is formed. In other words, it is possible for an emulsion to be formed at a certain moment, without this being observed by the user and/or without the user carrying out specific operations to make such an observation.

Dilution with water is preferably carried out at a temperature of less than 40° C., preferably less than 35° C., preferably preferably less than 30° C., preferably less than 25° C. Ambient temperature is typically employed. Contacting of the active ingredient and the solvent may be carried out especially at a temperature of less than 40° C., preferably less than 35° C., preferably preferably less than 30° C., preferably less than 25° C. Ambient temperature is typically employed.

Thus, as indicated above, the nanoparticles obtained by the process may have an average diameter as measured by light scattering of between 10 and 1000 nm, preferably between 20 and 500 nm, preferably between 50 and 400 nm, for example, between 100 and 300 nm. The nanoparticles obtained by the process may be amorphous.

Mixing with water may at least be carried out at a proportion of water relative to the solvent, D_{Nano}, of greater than D_{Emuls}, where D_{Nano} and D_{Emuls} are as described above.

In practice, the mixing with water may be such as to produce a dilution (of the formulation according to the invention) by a factor F of greater than or equal to 50/(miscibility in % of the solvent system), preferably F>100, preferably F<5000, preferably F<1000.

Moreover, mixing with water may be carried out at least at a proportion of water relative to the solvent of between 5/95 and 99.999/0.001, preferably between 95/5 and 99.999/0.001, preferably between 99/1 and 99.995/0.005, and preferably between 99.5/0.5 and 99.95/0.05.

Dilution with water is preferably carried out on the site of agricultural exploitation, in a tank from which the nanoparticle dispersion will be applied (a procedure known as tank mixing). The liquid crop protection formulation capable of forming ₜhe nanoparticles may thus be transported and/or stored before dilution is carried out. The level of active ingredient is therefore considered to be relatively important. This kind of method allows the costs of transport, storage, and handling to be optimized. The water content of the formulation capable of forming the nanoparticles, in this embodiment, is generally low, for example, typically less than 23% by weight.

According to another embodiment it is possible to carry out preliminary dilution at the production site of a crop protection formulation, to give the nanoparticles, and then to carry out redilution in a tank from which the nanoparticle dispersion will be applied. The prediluted product may thus be transported and/or stored before dilution is carried out. The water content is then considered to be relatively important. The water content of the formulation capable of forming the nanoparticles may in this embodiment be relatively high, for example, typically greater than 23% by weight, and indeed often greater than 50% by weight or 75% by weight.

The formulation and the process may therefore be used to prepare nanoparticles of an active organic crop protection ingredient and for treatment of plants.

The dilute formulation comprising the nanoparticles is subsequently applied to the fields or crops, by means of suitable apparatus, such as sprayers or aircraft such as airplanes, which broadcast the dilute formulation. The formulation may have a limited stability before crystallization, of less than 2 days, for example, or even less than 1 day, or even less than 10 hours. Its stability is generally greater than 2 hours, and usually greater than 3 hours. It is preferred that the dilute formulation comprising the nanoparticles is applied during the stability period. The preferred formulations are those which allow, in the diluted state, at the application rate, the production of nanoparticles with a stability of at least 3 hours, preferably of at least 5 hours.

Other details or advantages of the invention may emerge in light of the examples which follow, without limitative character.

### EXAMPLES

Ingredients Used

The amounts used are indicated in amounts as they are. The ingredients used do not substantially comprise water. The amounts are therefore substantially close to amounts of active ingredient or solids.

Characterizations

Size of the particles obtained after dilution: This is the hydrodynamic radius of the particles, obtained by light scattering measurement carried out on a Malvern ALV CGS-3 (the concentrations used are those indicated in the examples). The diameter measurements are made at 90° (D₉₀) and 135° (D₁₃₅) angle. The autocorrelation function provides two values: the average hydrodynamic diameter weighted by the scattered intensity, and a polydispersity index (dimensionless, referred to as Iₚ), which is close to zero for a monodisperse sample. The size is evaluated at 25° C., 30 minutes after preparation of the formulation.

The dilution range studied in examples 1 to 43 (typically 0.1% to 0.5% of the Nanoparticle Dispersible Concentrate (NDC)) corresponds typically to a possible range of concentration for field application. The range studied in the following examples corresponds to optimized dilutions.

All of the dispersions are stable for at least 3 hours.

### Example 1

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 0.9 g (9.3% by weight) of Alkamuls OR/36 (Rhodia) and 0.6 g (6.2% by weight) of Antarox B/848 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=110 nm with an Iₚ=0.11, D₁₃₅=105 nm with an Iₚ=0.13.

### Example 2

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 0.3 g (3.1% by weight) of Alkamuls OR/36 (Rhodia) and 1.2 g (12.4% by weight) of Antarox B/848 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=396 nm with an Iₚ=0.50, D₁₃₅=375 nm with an Iₚ=0.46.

### Example 3

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 1.2 g (12.4% by weight) of Alkamuls OR/36 (Rhodia) and 0.3 g (3.1% by weight) of Antarox B/848 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=116 nm with an Iₚ=0.10, D₁₃₅=114 nm with an Iₚ=0.14.

### Example 4

### Nanoparticles Based on Tebuconazole

In a test tube, using a stirrer, 2.62 g (27.8% by weight) of tebuconazole in solid form (Makhteshim Orius) are dissolved in 5.58 g (59.2% by weight) of Genagen 4166 (Clariant). This mixture is admixed with 1.22 g (13%) of surfactants, made up of 0.73 g (7.8% by weight) of Alkamuls OR/36 (Rhodia) and 0.49 g (5.2% by weight) of Antarox B/848 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=151 nm with an Iₚ=0.13, D₁₃₅=144 nm with an Iₚ=0.12.

### Example 5

### Nanoparticles Based on Tebuconazole

In a test tube, using a stirrer, 2.62 g (28.6% by weight) of tebuconazole in solid form (Makhteshim Orius) are dissolved in 5.58 g (60.8% by weight) of Genagen 4166 (Clariant). This mixture is admixed with 0.97 g (10.6%) of surfactants, made up of 0.58 g (6.3% by weight) of Alkamuls OR/36 (Rhodia) and 0.39 g (4.3% by weight) of Antarox B/848 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=186 nm with an Iₚ=0.15, D₁₃₅=170 nm with an Iₚ=0.15.

### Example 6

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.44 g (4.9% by weight) of Alkamuls OR/36 (Rhodia) and 0.29 g (3.3% by weight) of Antarox B/848 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=217 nm with an Iₚ=0.21, D₁₃₉=197 nm with an Iₚ=0.18.

### Example 7

### Nanoparticles Based on Tebuconazole

In a test tube, using a stirrer, 2.62 g (30.2% by weight) of tebuconazole in solid form (Makhteshim Orius) are dissolved in 5.58 g (64.3% by weight) of Genagen 4166 (Clariant). This mixture is admixed with 0.48 g (5.5%) of surfactants, made up of 0.29 g (3.3% by weight) of Alkamuls OR/36 (Rhodia) and 0.19 g (2.2% by weight) of Antarox B/848 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=402 nm with an Iₚ=0.42, D₁₃₅=312 nm with an Iₚ=0.43.

### Example 8

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 0.84 g (8.7% by weight) of Alkamuls OR/36 (Rhodia) and 0.66 g (6.8% by weight) of Antarox PLG/254 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=764 nm with an Iₚ=0.46, D₁₃₅=631 nm with an Iₚ=0.52.

### Example 9

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.41 g (4.6% by weight) of Alkamuls OR/36 (Rhodia) and 0.32 g (3.6% by weight) of Antarox PLG/254 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=600 nm with an Iₚ=1.18, D₁₃₅=920 nm with an Iₚ=0.40.

### Example 10

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 1.25 g (12.9% by weight) of Alkamuls OR/36 (Rhodia) and 0.25 g (2.6% by weight) of Antarox PL/122 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=97 nm with an Iₚ=0.16, D₁₃₅=92 nm with an Iₚ=0.10.

### Example 11

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.61 g (6.8% by weight) of Alkamuls OR/36 (Rhodia) and 0.12 g (1.4% by weight) of Antarox PL/122 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=317 nm with an Iₚ=0.18, D₁₃₅=298 nm with an Iₚ=0.26.

### Example 12

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 0.45 g (4.6% by weight) of Antarox B/848 (Rhodia) and 1.05 g (10.9% by weight) of Soprophor BSU (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=100 nm with an Iₚ=0.10, D₁₃₅=95 nm with an Iₚ=0.10.

### Example 13

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.22 g (2.5% by weight) of Antarox B/848 (Rhodia) and 0.51 g (5.7% by weight) of Soprophor BSU (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=220 nm with an Iₚ=0.05, D₁₃₅=208 nm with an Iₚ=0.06.

### Example 14

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 0.58 g (6% by weight) of Antarox PL/122 (Rhodia) and 0.92 g (9.5% by weight) of Soprophor 3D33 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=96 nm with an Iₚ=0.21, D₁₁₅=93 nm with an Iₚ=0.15.

### Example 15

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.28 g (3.2% by weight) of Antarox PL/122 (Rhodia) and 0.45 g (5% by weight) of Soprophor 3D33 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=230 nm with an Iₚ=0.16, D₁₃₅=206 nm with an Iₚ=0.19.

### Example 16

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 0.38 g (3.9% by weight) of Alkalmuls R/81 (Rhodia) and 1.12 g (11.6% by weight) of Soprophor BSU (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=204 nm with an Iₚ=0.09, D₁₃₅=178 nm with an Iₚ=0.23.

### Example 17

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.18 g (2.1% by weight) of Alkamuls R/81 (Rhodia) and 0.55 g (6.1% by weight) of Soprophor BSU (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=199 nm with an Iₚ=0.13, D₁₃₅=185 nm with an Iₚ=0.09.

### Example 18

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 0.88 g (9.1% by weight) of Alkalmuls RC (Rhodia) and 0.62 g (6.4% by weight) of Antarox B/500 (Rhodia). The system is stirred until a clear solution is obtained which is called an NDC. Dilution of 0.1 g of this NDC in 100 ml of water gives, after 30 inversions of the test tube, nanoparticles with diameters measured at D₉₃=395 nm with an Iₚ=0.17, D₁₃₅=348 nm with an Iₚ=0.33.

### Example 19

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.43 g (4.8% by weight) of Alkamuls RC (Rhodia) and 0.30 g (3.4% by weight) of Antarox B/500 (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=646 nm with an Iₚ=0.19, D₁₃₅=571 nm with an Iₚ=0.21.

### Example 20

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Genagen 4166 (Clariant). This mixture is admixed with 1.5 g (15.5%) of surfactants, made up of 1.08 g (11.1% by weight) of Alkalmuls OR/36 (Rhodia) and 0.42 g (4.4% by weight) of Rhodacal 60/BE (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=211 nm with an Iₚ=0.15, D₁₃₅=192 nm with an Iₚ=0.22.

### Example 21

### Nanoparticles Based on Tebuconazole

In a test tube, using a stirrer, 2.62 g (29.3% by weight) of tebuconazole in solid form (Makhteshim Orius) are dissolved in 5.58 g (62.5% by weight) of Genagen 4166 (Clariant). This mixture is admixed with 0.73 g (8.2%) of surfactants, made up of 0.52 g (5.9% by weight) of Alkamuls OR/36 (Rhodia) and 0.21 g (2.3% by weight) of Rhodacal 60/BE (Rhodia). The system is stirred until a clear solution is obtained which is called an NDC. Dilution of 0.1 g of this NDC in 100 ml of water gives, after 30 inversions of the test tube, nanoparticles with diameters measured at D₉₀=401 nm with an Iₚ=0.40, D₁₃₅=341 nm with an Iₚ=0.54.

### Example 22

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 0.79 g (8.10% by weight) of Soprophor 3D33 (Rhodia) and 0.72 g (7.40% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=109 nm with an Iₚ=0.07, D₁₃₅=111 nm with an Iₚ=0.08.

Dilution of 0.5 g of this NDC in 100 ml of water gives, after 30 inversions of the test tube, nanoparticles with diameters measured at D₉₀=101 nm with an Iₚ=0.19, D₁₃₅=112 nm with an Iₚ=0.09.

### Example 23

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10. This mixture is admixed with 1.5 g (15.5%) of surfactants, made up of 0.82 g (8.45% by weight) of Soprophor 3D33 (Rhodia) and 0.68 g (7.05% by weight) of Antarox PL/122 (Rhodia). The system is stirred until a clear solution NDC is obtained.

Dilution of 0.1 g of this NDC in 100 ml of water gives, after 30 inversions of the test tube, nanoparticles with diameters measured at D₉₀=101 nm with an Iₚ=0.11, D₁₃₅=101 nm with an Iₚ=0.09.

Dilution of 0.5 g of this NDC in 100 ml of water gives, after 30 inversions of the test tube, nanoparticles with diameters measured at D₉₀=97 nm with an Iₚ=0.18, D₁₃₅=105 nm with an Iₚ=0.15.

### Example 24

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 0.89 g (9.16% by weight) of Soprophor 3D33 (Rhodia) and 0.62 g (6.34% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=109 nm with an Iₚ=0.12, D₁₃₅=108 nm with an Iₚ=0.10.

Dilution of 0.5 g of this NDC in 100 ml of water gives, after 30 inversions of the test tube, nanoparticles with diameters measured at D₉₀=98 nm with an Iₚ=0.19, D₁₃₅=103 nm with an Iₚ=0.12.

### Example 25

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 0.92 g (9.5% by weight) of Soprophor 3D33 (Rhodia) and 0.58 g (6% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=98 nm with an Iₚ=0.06, D₁₃₅=101 nm with an Iₚ=0.04.

Dilution of 0.5 g of this NDC in 100 ml of water gives, after 30 inversions of the test tube, nanoparticles with diameters measured at D₉₀=93 nm with an Iₚ=0.12, D₁₃₅=100 nm with an Iₚ=0.08.

### Example 26

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 0.96 g (9.86% by weight) of Soprophor 3D33 (Rhodia) and 0.55 g (5.64% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=99 nm with an Iₚ=0.07, D₁₃₅=100 nm with an Iₚ=0.06.

Dilution of 0.5 g of this NDC in 100 ml of water gives, after 30 inversions of the test tube, nanoparticles with diameters measured at D₉₀=90 nm with an Iₚ=0.13, D₁₃₅=97 nm with an Iₚ=0.09.

### Example 27

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 1.03 g (10.57% by weight) of Soprophor 3D33 (Rhodia) and 0.48 g (4.93% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=88 nm with an Iₚ=0.03, D₁₃₅=88 nm with an Iₚ−0.04.

Dilution of 0.5 g of this NDC in 100 ml of water gives, after 30 inversions of the test tube, nanoparticles with diameters measured at D₉₀=88 nm with an Iₚ=0.09, D₁₃₅=92 nm with an Iₚ=0.06.

### Example 28

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 1.06 g (10.92% by weight) of Soprophor 3D33 (Rhodia) and 0.44 g (4.58% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=88 nm with an Iₚ=0.04, D₁₃₅=88 nm with an Iₚ=0.04.

Dilution of 0.5 g of this NDC in 100 ml of water gives, after 30 inversions of the test tube, nanoparticles with diameters measured at D₉₀=88 nm with an Iₚ=0.14, D₁₃₅=93 nm with an Iₚ=0.1.

### Example 29

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 1.09 g (11.27% by weight) of Soprophor 3D33 (Rhodia) and 0.41 g (4.23% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=82 nm with an Iₚ=0.06, D₁₃₅=82 nm with an Iₚ−0.08.

Dilution of 0.5 g of this NDC in 100 ml of water gives, after 30 inversions of the test tube, nanoparticles with diameters measured at D₉₀=84 nm with an Iₚ=0.12, D₁₃₅=89 nm with an Iₚ=0.1.

### Example 30

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 1.16 g (11.98% by weight) of Soprophor 3D33 (Rhodia) and 0.34 g (3.52% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=86 nm with an Iₚ=0.01, D₁₃₅=84 nm with an Iₚ=0.09.

Dilution of 0.5 g of this NDC in 100 ml of water gives, after 30 inversions of the test tube, nanoparticles with diameters measured at D₉₀=78 nm with an Iₚ=0.09, D₁₃₅=80 nm with an Iₚ=0.09.

### Example 31

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 1.23 g (12.68% by weight) of Soprophor 3D33 (Rhodia) and 0.27 g (2.82% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=101 nm with an Iₚ=0.07, D₁₃₅=99 nm with an Iₚ=0.04.

Dilution of 0.5 g of this NDC in 100 ml of water gives, after 30 inversions of the test tube, nanoparticles with diameters measured at D₉₀=79 nm with an Iₚ=0.15, D₁₃₅=82 nm with an Iₚ=0.08.

### Example 32

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 10 (Rhodia). This mixture is admixed with 1.5 g (15.5%) of surfactants, made up of 1.30 g (13.39% by weight) of Soprophor 3D33 (Rhodia) and 0.21 g (2.11% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=94 nm with an Iₚ=0.02, D₁₃₅=95 nm with an Iₚ=0.07.

Dilution of 0.5 g of this NDC in 100 ml of water gives, after 30 inversions of the test tube, nanoparticles with diameters measured at D₉₀=107 nm with an Iₚ=0.42, D₁₃₅=138 nm with an Iₚ=0.34.

### Example 33

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.62 g (6.34% by weight) of Soprophor 3D33 (Rhodia) and 0.89 g (9.16% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=76 nm with an Iₚ=0.06, D₁₃₅=80 nm with an Iₚ=0.01.

Dilution of 0.5 g of this NDC in 100 ml of water gives, after 30 inversions of the test tube, nanoparticles with diameters measured at D₉₀=82 nm with an Iₚ=0.08, D₁₃₅=90 nm with an Iₚ=0.05.

### Example 34

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.68 g (7.05% by weight) of Soprophor 3D33 (Rhodia) and 0.82 g (8.45% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=218 nm with an Iₚ=0.23, D₁₃₅=174 nm with an Iₚ=0.26.

Dilution of 0.5 g of this NDC in 100 ml of water gives, after 30 inversions of the test tube, nanoparticles with diameters measured at D₉₀=252 nm with an Iₚ=0.41, D₁₃₅=40 nm with an Iₚ=0.41.

### Example 35

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.75 g (7.75% by weight) of Soprophor 3D33 (Rhodia) and 0.75 g (7.75% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=67 nm with an Iₚ=0.04, D₁₃₅=67 nm with an Iₚ=0.06.

### Example 36

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.79 g (8.10% by weight) of Soprophor 3D33 (Rhodia) and 0.72 g (7.40% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=71 nm with an Iₚ=0.08, D₁₃₅=73 nm with an Iₚ=0.03.

### Example 37

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.82 g (8.45% by weight) of Soprophor 3D33 (Rhodia) and 0.68 g (7.05% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=74 nm with an Iₚ=0.04, D₁₃₅=74 nm with an Iₚ=0.08.

### Example 38

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.89 g (9.16% by weight) of Soprophor 3D33 (Rhodia) and 0.62 g (6.34% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=76 nm with an Iₚ=0.09, D₁₃₅=74 nm with an Iₚ=0.08.

### Example 39

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.92 g (9.5% by weight) of Soprophor 3D33 (Rhodia) and 0.58 g (6% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=86 nm with an Iₚ=0.08, D₁₃₅=87 nm with an Iₚ=0.08.

### Example 40

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 0.96 g (9.86% by weight) of Soprophor 3D33 (Rhodia) and 0.55 g (5.64% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=77 nm with an Iₚ=0.1, D₁₃₅=77 nm with an Iₚ=0.06.

### Example 41

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 1.03 g (10.57% by weight) of Soprophor 3D33 (Rhodia) and 0.48 g (4.93% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=78 nm with an Iₚ=0.07, D₁₃₅=77 nm with an Iₚ=0.1.

### Example 42

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 1.06 g (10.92% by weight) of Soprophor 3D33 (Rhodia) and 0.44 g (4.58% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=88 nm with an Iₚ=0.14, D₁₃₅=86 nm with an Iₚ=0.14.

### Example 43

### Nanoparticles Based on Tebuconazole

In a test tube, using a stirrer, 2.62 g (27% by weight) of tebuconazole in solid form (Makhteshim Orius) are dissolved in 5.58 g (57.5% by weight) of Rhodiasolv® ADMA 810 (Rhodia). This mixture is admixed with 1.5 g (15.5%) of surfactants, made up of 1.30 g (13.39% by weight) of Soprophor 3D33 (Rhodia) and 0.21 g (2.11% by weight) of Antarox PL/122 (Rhodia). The system is stirred until a clear solution is obtained which is called an NDC.

Dilution of 0.1 g of this NDC in 100 ml of water gives, after 30 inversions of the test tube, nanoparticles with diameters measured at D₉₀=139 nm with an Iₚ=0.18, D₁₃₅=121 nm with an Iₚ=0.22.

### Example 44

### Nanoparticles Based on Tebuconazole

In a 250 ml pyrex flask, with stirring with a magnetized bar, 54.0 g (27% by weight) of tebuconazole in solid form (Makhteshim Orius) are dissolved in a mixture containing 31 g (15.5% by weight) of surfactants, made up of 21 g (10.5% by weight) of Soprophor 3D33 (Rhodia) and 10 g (5% by weight) of Antarox PL122 (Rhodia) and 115 g (57.5% by weight) of Rhodiasolv® ADMA 10. The system is stirred until a clear solution is obtained which is called an NDC.

Dilution of 62.5 μl of this NDC in 100 ml of water (i.e., 0.156 g/l of active ingredient) gives, after 3 inversions of the test tube, nanoparticles with diameters measured at D₉₀=97 nm with an Iₚ=0.24, D₁₃₅=97 nm with an Iₚ=0.14.

Dilution of 43.7 μl of this NDC in 100 ml of water (i.e., 0.109 g/l of active ingredient) gives, after 3 inversions of the test tube, nanoparticles with diameters measured at D₉₀=104 nm with an Iₚ=0.19, D₁₃₅=98 nm with an Iₚ=0.17.

Dilution of 25.0 μl of this NDC in 100 ml of water (i.e., 0.062 g/l of active ingredient) gives, after 3 inversions of the test tube, nanoparticles with diameters measured at D₉₀=109 nm with an Iₚ=0.23, D₁₃₅=101 nm with an Iₚ=0.09.

Storage of this NDC for 7 days at 0° C. (CIPAC test MT 39) does not change the appearance of the NDC (no crystals appear).

Dilution of 62.5 μl of this NDC stored at 0° C. in 100 ml of water (i.e., 0.156 g/l of active ingredient) gives, after 3 inversions of the test tube, nanoparticles with diameters measured at D₉₀=90 nm with an Iₚ=0.15, D₁₃₅=96 nm with an Iₚ=0.13.

Dilution of 43.7 μl of this NDC stored at 0° C. in 100 ml of water (i.e., 0.109 g/l of active ingredient) gives, after 3 inversions of the test tube, nanoparticles with diameters measured at D₉₀=92 nm with an Iₚ=0.09, D₁₃₅=93 nm with an Iₚ=0.08.

Dilution of 25.0 μl of this NDC stored at 0° C. in 100 ml of water (i.e., 0.062 g/l of active ingredient) gives, after 3 inversions of the test tube, nanoparticles with diameters measured at D₉₀=93 nm with an Iₚ=0.09, D₁₃₅=91 nm with an Iₚ=0.06.

Storage of this NDC for 14 days at 54° C. (CIPAC test MT 46) does not change the appearance of the NDC (no crystals appear).

Dilution of 62.5 μl of this NDC stored at 54° C. in 100 ml of water (i.e., 0.156 g/l of active ingredient) gives, after 3 inversions of the test tube, nanoparticles with diameters measured at D₉₀=97 nm with an Iₚ=0.23, D₁₃₅=96 nm with an Iₚ=0.11.

Dilution of 43.7 μl of this NDC stored at 54° C. in 100 ml of water (i.e., 0.109 g/l of active ingredient) gives, after 3 inversions of the test tube, nanoparticles with diameters measured at D₉₀=99 nm with an Iₚ=0.21, D₁₃₅=97 nm with an Iₚ=0.14.

Dilution of 25.0 μl of this NDC stored at 54° C. in 100 ml of water (i.e., 0.062 g/l of active ingredient) gives, after 3 inversions of the test tube, nanoparticles with diameters measured at D₉₀=106 nm with an Iₚ=0.21, D₁₃₅=97 nm with an Iₚ=0.14.

### Example 45

### Nanoparticles Based on Tebuconazole

In a 250 ml pyrex flask, with stirring with a magnetized bar, 54.0 g (27% by weight) of tebuconazole in solid form (Makhteshim Orius) are dissolved in a mixture containing 31 g (15.5% by weight) of surfactants, made up of 28.7 g (14.35% by weight) of Alkamuls OR 36 (Rhodia) and 2.3 g (1.15% by weight) of Antarox PL122 (Rhodia) and 115 g (57.5% by weight) of Rhodiasolv® ADMA 10. The system is stirred until a clear solution is obtained which is called an NDC.

Dilution of 62.5 μl of this NDC in 100 ml of water (i.e., 0.156 g/l of active ingredient) gives, after 3 inversions of the test tube, nanoparticles with diameters measured at D₉₀=128 nm with an Iₚ=0.24, D₁₃₅=136 nm with an Iₚ=0.14.

Dilution of 43.7 μl of this NDC in 100 ml of water (i.e., 0.109 g/l of active ingredient) gives, after 3 inversions of the test tube, nanoparticles with diameters measured at D₉₀=146 nm with an Iₚ=0.23, D₁₃₅=141 nm with an Iₚ=0.11.

Dilution of 25.0 μl of this NDC in 100 ml of water (i.e., 0.062 g/l of active ingredient) gives, after 3 inversions of the test tube, nanoparticles with diameters measured at D₉₀=159 nm with an Iₚ=0.24, D₁₃₅=142 nm with an Iₚ=0.14.

Storage of this NDC for 7 days at 0° C. (CIPAC test MT 39) does not change the appearance of the NDC (no crystals appear).

Dilution of 62.5 μl of this NDC stored at 0° C. in 100 ml of water (i.e., 0.156 g/l of active ingredient) gives, after 3 inversions of the test tube, nanoparticles with diameters measured at D₉₀=127 nm with an Iₚ=0.24, D₁₃₅=136 nm with an Iₚ=0.16.

Dilution of 43.7 μl of this NDC stored at 0° C. in 100 ml of water (i.e., 0.109 g/l of active ingredient) gives, after 3 inversions of the test tube, nanoparticles with diameters measured at D₉₀=140 nm with an Iₚ=0.22, D₁₃₅=139 nm with an Iₚ=0.09.

Dilution of 25.0 μl of this NDC stored at 0° C. in 100 ml of water (i.e., 0.062 g/l of active ingredient) gives, after 3 inversions of the test tube, nanoparticles with diameters measured at D₉₀=141 nm with an Iₚ=0.15, D₁₃₅=132 nm with an Iₚ=0.15.

Storage of this NDC for 14 days at 54° C. (CIPAC test MT 46) does not change the appearance of the NDC (no crystals appear).

Dilution of 62.5 μl of this NDC stored at 54° C. in 100 ml of water (i.e., 0.156 g/l of active ingredient) gives, after 3 inversions of the test tube, nanoparticles with diameters measured at D₉₀=134 nm with an Iₚ=0.30, D₁₃₅=145 nm with an Iₚ=0.26.

Dilution of 43.7 μl of this NDC stored at 54° C. in 100 ml of water (i.e., 0.109 g/l of active ingredient) gives, after 3 inversions of the test tube, nanoparticles with diameters measured at D₉₀=150 nm with an Iₚ=0.23, D₁₃₅=152 nm with an Iₚ=0.212.

Dilution of 25.0 μl of this NDC stored at 54° C. in 100 ml of water (i.e., 0.062 g/l of active ingredient) gives, after 3 inversions of the test tube, nanoparticles with diameters measured at D₉₀=149 nm with an Iₚ=0.18, D₁₃₅=139 nm with an Iₚ=0.13.

### Example 46

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.182 g (3.64% by weight) of Soprophor 3D33 (Rhodia) and 0.818 g (16.36% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=213 nm with an Iₚ=0.262; D₁₃₅=208 nm with an Iₚ=0.176.

### Example 47

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.273 g (5.45% by weight) of Soprophor 3D33 (Rhodia) and 0.727 g (14.55% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=158 nm with an Iₚ=0.344; D₁₃₅=137 nm with an Iₚ=0.26.

Dilution of 0.357 g of this NDC in 100 ml of CIPAC D water (342 ppm) gives, after 30 inversions of the test tube, nanoparticles with diameters measured at D₉₀=116 nm with an Iₚ=0.253; D₁₃₅=112 nm with an Iₚ=0.172.

Dilution of 0.357 g of this NDC in 100 ml of 1000 ppm water gives, after 30 inversions of the test tube, nanoparticles with diameters measured at D₉₀=118 nm with an Iₚ=0.232; D₁₃₅=112 nm with an Iₚ=0.169.

### Example 48

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.364 g (7.27% by weight) of Soprophor 3D33 (Rhodia) and 0.636 g (12.73% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=206 nm with an Iₚ=0.179; D₁₃₅=182 nm with an Iₚ=0.31.

### Example 49

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.455 g (9.09% by weight) of Soprophor 3D33 (Rhodia) and 0.545 g (10.91% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=202 nm with an Iₚ=0.734; D₁₃₅=212 nm with an Iₚ=0.25.

### Example 50

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.545 g (10.91% by weight) of Soprophor 3D33 (Rhodia) and 0.455 g (9.09% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=224 nm with an Iₚ=1.17; D₁₃₅=231 nm with an Iₚ=0.219.

### Example 51

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.636 g (12.73% by weight) of Soprophor 3D33 (Rhodia) and 0.364 g (7.27% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=193 nm with an Iₚ=1.54; D₁₃₅=225 nm with an Iₚ=0.134.

### Example 52

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.727 g (14.55% by weight) of Soprophor 3D33 (Rhodia) and 0.273 g (5.45% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=187 nm with an Iₚ=0.56; D₁₃₅=215 nm with an Iₚ=0.206.

### Example 53

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.818 g (16.36% by weight) of Soprophor 3D33 (Rhodia) and 0.182 g (3.64% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=170 nm with an Iₚ=1.41; D₁₃₅=235 nm with an Iₚ=0.0958.

### Example 54

### Nanoparticles Based on Fipronil

In a test tube, using a stirrer, 1.4 g (28% by weight) of fipronil in solid form are dissolved in 2.6 g (52% by weight) of Rhodiasolv® ADMA 10 (Rhodia). This mixture is admixed with 1 g (20%) of surfactants, made up of 0.909 g (18.18% by weight) of Soprophor 3D33 (Rhodia) and 0.091 g (1.82% by weight) of Antarox PL/122 (Rhodia). The system is stirred until a clear solution is obtained which is called an NDC.

Dilution of 0.357 g of this NDC in 100 ml of water gives, after 30 inversions of the test tube, nanoparticles with diameters measured at D₉₀=171 nm with an Iₚ=1.13; D₁₃₅=238 nm with an Iₚ=0.156.

### Example 55

### Nanoparticles Based on Pendimethalin

In a glass tablet bottle, 2.5 g of Soprophor 3D33 (5% by weight) (Rhodia) are dissolved in 35.0 g (70% by weight) of Rhodiasolv ADMA 10 (Rhodia). The mixture is admixed with 12.5 g (25% by weight) of pendimethalin (BASF). The system is heated (to facilitate the dissolution of the active ingredient) at 54° C. and stirred until a clear solution is obtained, which is referred to as an NDC.

Dilution of 0.05 g of this NDC in 100 ml of water gives, after 30 inversions of the test tube, nanoparticles with diameters measured as D₉₀=206 nm with an Iₚ=0.136, D₁₃₅=194 nm with an Iₚ=0.126.

This nanometer-size dispersion is stable for 24 hours at ambient temperature.

### Example 56

### Nanoparticles Based on Pendimethalin

In a glass tablet bottle, 1.5 g of Alkamuls 14/R (15% by weight) (Rhodia) are dissolved in 6.0 g (60% by weight) of Rhodiasolv ADMA 10 (Rhodia). The mixture is admixed with 2.5 g (25% by weight) of pendimethalin (BASF). The system is heated at 54° C. (to facilitate the dissolution of the active ingredient) and stirred until a clear solution is obtained, which is referred to as an NDC.

Dilution of 0.5 g of this NDC in 100 ml of water gives, after 10 inversions of the test tube, nanoparticles with diameters measured as D₉₀=125 nm with an Iₚ=0.24, D₁₃₅=136 nm with an Iₚ=0.179.

After 24 hours at 30° C. the diameters measured are D₉₀=111 nm with an Iₚ=0.453, D₁₃₅=150 nm with an Iₚ=0.338.

### Example 57

### Nanoparticles Based on Pendimethalin

In a glass tablet bottle, 1.5 g of Soprophor 3D33 (15% by weight) (Rhodia) are dissolved in 6.0 g (60% by weight) of Rhodiasolv ADMA 810 (Rhodia). The mixture is admixed with 2.5 g (25% by weight) of pendimethalin (BASF). The system is heated at 50° C. (to facilitate the dissolution of the active ingredient) and stirred until a clear solution is obtained, which is referred to as an NDC.

Dilution of 0.5 g of this NDC in 100 ml of water gives, after 10 inversions of the test tube, nanoparticles with diameters measured as D₉₀=41 nm with an Iₚ=0.062, D₁₃₅=41 nm with an Iₚ=0.068.

After 24 hours at 30° C. the diameters measured are D₉₀=68 nm with an Iₚ=0.159, D₁₃₅=70 nm with an Iₚ=0.1; the solution which was completely clear to start with has undergone slight opacification.

Dilution of 0.5 g of this NDC in 100 ml of water gives, after 10 inversions of the test tube, nanoparticles with diameters measured 6 hours after dilution as D₉₀=56 nm with an Iₚ=0.214, D₁₃₅=52 nm with an Iₚ=0.167.

Dilution of 1.0 g of this NDC in 100 ml of water gives, after 10 inversions of the test tube, nanoparticles with diameters measured 6 hours after dilution as D₉₀=99 nm with an Iₚ=0.421, D₁₃₅=75 nm with an Iₚ=0.378.

Dilution of 0.5 g of this NDC, after accelerated aging in an oven (CIPAC MT 46), in 100 ml of water gives, after 10 inversions of the test tube, nanoparticles. After 1 month at 45° C., the diameters measured 6 hours after dilution are D₉₀=57 nm with an Iₚ=0.236, D₁₃₅=55 nm with an Iₚ=0.155.

After 15 days at 54° C., the diameters measured 6 hours after dilution are D₉₀=57 nm with an Iₚ=0.231, D₁₃₅=55 nm with an Iₚ=0.149.

After 1 month in a −5/+45° C. cycle, the diameters measured 6 hours after dilution are D₉₀=57 nm with an Iₚ=0.238, D₁₃₅=55 nm with an Iₚ=0.155.

### Example 58

### Nanoparticles Based on Pendimethalin

In a glass tablet bottle, 1.5 g of Alkamuls 14/R (15% by weight) (Rhodia) are dissolved in 6.0 g (60% by weight) of Rhodiasolv ADMA 810 (Rhodia). The mixture is admixed with 2.5 g (25% by weight) of pendimethalin (BASF). The system is heated at 50° C. (to facilitate the dissolution of the active ingredient) and stirred until a clear solution is obtained, which is referred to as an NDC.

Dilution of 0.5 g of this NDC in 100 ml of water gives, after 10 inversions of the test tube, nanoparticles with diameters measured as D₉₀=267 nm with an Iₚ=0.475, D₁₃₅=225 nm with an Iₚ=0.413.

After 24 hours at 30° C. the diameters measured are D₉₀=183 nm with an Iₚ=0.471, D₁₃₅=195 nm with an Iₚ=0.365.

1-26. (canceled)

27. A liquid crop protection formulation capable of forming, upon mixing with water, solid or liquid nanoparticles of a water-insoluble active crop protection ingredient, said formulation comprising:
a) a water-insoluble organic active crop protection ingredient,
b) a partially water-miscible solvent system having a miscibility in water ranging from 0.001% to 10%, and
c) an amphiphilic system,
wherein, if the amphiphilic system consists of a block copolymer of ethylene oxide and C₃-C₁₀ alkylene oxide, then the solvent system has a miscibility in water of less than 1%.

28. The formulation of claim 27, wherein said amphiphilic system comprises a surfactant.

29. The formulation of claim 27, comprising less than 23% by weight of water.

30. The formulation of claim 27, wherein said formulation:
is single-phase,
forms an oil-in-water emulsion upon mixing with a proportion of water relative to the solvent, and
forms a nanoparticle dispersion upon mixing with a proportion of water relative to the solvent,
wherein the proportion of water forming the nanoparticle dispersion is greater than the proportion of water forming the oil-in-water emulsion.

31. The formulation of claim 27, wherein the solvent system comprises at least 33% by weight of a solvent comprising:
N,N-dialkyl amides of a carboxylic acid,
ketones,
alkylpyrrolidones in which the alkyl group is C₃-C₁₈,
aldehydes,
monoesters, diesters or oxalates,
ethers,
halogenated solvents,
alcohols,
phosphate, phosphonate, phosphinate, phosphine, or phosphine oxide solvents,
nitriles,
amines,
lactones,
carbonates, or
mixtures or combinations thereof,
wherein said solvents, mixtures or combinations have a miscibility in water ranging from 0.001% to 10%.

32. The formulation of claim 27, wherein the active crop protection ingredient comprises an azole.

33. The formulation of claim 32, wherein the active crop protection ingredient is tebuconazole.

34. The formulation of claim 27, wherein the amphiphilic system has an HLB of greater than or equal to 6.

35. The formulation of claim 27, wherein the amphiphilic system comprises:
at least one amphiphilic compound with an HLB of less than 10, and
at least one amphiphilic compound with an HLB of greater than or equal to 10.

36. The formulation of claim 35, wherein the amphiphilic system comprises:
at least one amphiphilic compound with an HLB of less than 9, and/or
at least one amphiphilic compound with an HLB of greater than or equal to 11.

37. The formulation of claim 35, comprising at least two amphiphilic compounds having a difference in HLB of greater than or equal to 2.

38. The formulation of claim 27, comprising:
at least one amphiphilic compound with a molar mass of less than 1000 g/mol, and
at least one amphiphilic compound with a molar mass of greater than or equal to 1000 g/mol.

39. The formulation of claim 38, wherein the amphiphilic compound with a molar mass of greater than or equal to 1000 g/mol is a polymeric compound.

40. The formulation of claim 39, wherein the polymeric compound comprises:
block copolymers of ethylene oxide and C₃-C₁₀ alkylene oxide,
amphiphilic block copolymers, comprising at least one block, comprising units deriving from ethylenically unsaturated monomers, or
mixtures thereof.

41. The formulation of claim 27, wherein the amphiphilic system comprises at least one amphiphilic compound comprising:
ethoxylated and/or propoxylated fatty alcohols,
ethoxylated and/or propoxylated fatty acids,
unalkoxylated fatty acids,
block copolymers of poly(ethylene oxide) and poly(propylene oxide),
ethoxylated and/or propoxylated di- and/or tri-styrylphenols, optionally phosphated or sulfated,
alkyl sulfates or alkylsulfonates wherein the alkyl is C₆-C₃₀, or
mixtures or combinations thereof.

42. The formulation of claim 27, comprising:
from 1% to 89.9% by weight of the organic active crop protection ingredient,
from 10% to 80% by weight of the partially water-miscible solvent system, and
from 0.1% to 35% by weight of the amphiphilic system.

43. The formulation of claim 27, comprising from 7% to 30% by weight of the amphiphilic system.

44. The formulation of claim 27, wherein the weight ratio between the organic active crop protection ingredient and the amphiphilic system ranges from 0.5 to 5.

45. The formulation of claim 27, wherein the weight ratio between the organic active crop protection ingredient and the solvent system ranges from 0.05 to 5.

46. The formulation of claim 27, wherein said formulation forms, upon mixing with water, solid or liquid nanoparticles having an average diameter as measured by light scattering ranging from 10 to 1000 nm.

47. The formulation of claim 27, wherein said formulation forms, upon mixing with water, amorphous nanoparticles.

48. A process for preparing a dispersion of solid or liquid nanoparticles of an organic active crop protection ingredient, comprising mixing the formulation of claim 27 with water.

49. The process of claim 48, wherein the nanoparticles have an average diameter as measured by light scattering ranging from 10 to 1000 nm.

50. The process of claim 48, wherein the nanoparticles are amorphous.

51. The process of claim 48, wherein said formulation
forms an oil-in-water emulsion upon mixing with a proportion of water relative to the solvent, and
forms a nanoparticle dispersion upon mixing with a proportion of water relative to the solvent,
wherein the proportion of water forming the nanoparticle dispersion is greater than the proportion of water forming the oil-in-water emulsion.

52. The process of claim 48, wherein the formulation is mixed with water to produce a dilution with a factor F of greater than or equal to 50/(miscibility in % of the solvent system).

53. The process of claim 48, wherein said formulation is mixed with water in at least at a proportion of water relative to the solvent ranging from 5/95 to 99.999/0.001.
